(19) United States
(12) Patent Application Publication
(10) Pub. No.: US 2016/0309770 A1
(43) Pub. Date: Oct. 27, 2016

(54) TRANSLUCENT, HIGH ACID, LOW VISCOSITY, HIGH CALORIC DENSITY NUTRITIONAL COMPOSITION

(71) Applicant: ABBOTT LABORATORIES, Abbott Park, IL (US)

(72) Inventors: KELLEY LOWE, POWELL, OH (US); TIMOTHY CHAPMAN, Grove City, OH (US); NORMANELLA DEWILLE, Columbus, OH (US); DOUGLAS WEARLY, Blacklick, OH (US)

(73) Assignee: ABBOTT LABORATORIES, Abbott Park, IL (US)

(21) Appl. No.: 15/105,373

(22) PCT Filed: Dec. 18, 2014
(86) PCT No.: PCT/US2014/071197

§ 371 Date: Jun. 16, 2016

Related U.S. Application Data
(60) Provisional application No. 61/918,266, filed on Dec. 19, 2013.

(51) Int. Cl. A23L 33/00; A23L 33/18; A23L 33/185; A23L 33/19; A23L 29/00; A23L 33/12

(52) U.S. Cl. CPC A23L 33/40; A23L 29/015; A23L 33/12; A23L 33/185; A23L 33/19; A23L 33/18; A23V 2002/00

(57) ABSTRACT

A translucent, high acid, low viscosity, high caloric density liquid nutritional composition and methods of making the liquid nutritional composition are provided. The liquid nutritional composition is translucent and has a viscosity of 25 to 100 centipoise, a caloric density of 50 to 200 kcal per 100 mL, and a pH of 2 to 4.6.

### CROSS-REFERENCE TO RELATED APPLICATIONS

This application claims priority to and any benefit of U.S. Provisional Application No. 61/918,266, filed Dec. 19, 2013, the content of which is incorporated herein by reference in its entirety.

### FIELD

The general inventive concepts relate to nutritional compositions. More particularly, the general inventive concepts relate to a translucent, high acid, low viscosity, high caloric density liquid nutritional composition and methods of making the liquid nutritional composition.

### BACKGROUND

Organoleptic characteristics such as mouthfeel play an important role in the selection of liquid nutritional compositions by consumers. Many liquid nutritional compositions that have a high protein content, a high caloric density, or both are formulated as viscous emulsions, which some consumers may find undesirable. In addition, some populations of consumers, for example, the elderly or the chronically ill, may not be able to completely consume the volume of viscous nutritional composition necessary to deliver the recommended amount of nutrients.

### SUMMARY

Provided herein are liquid nutritional compositions that have a low viscosity and a high caloric density. The liquid nutritional compositions disclosed herein are translucent and acidic, yet provide a desirable amount of protein. Also provided herein are related methods of making the liquid nutritional compositions.

In one exemplary embodiment, a translucent, high acid, low viscosity, high caloric density liquid nutritional composition is provided. The liquid nutritional composition comprises 3 grams to 10.5 grams of protein per 100 mL of the nutritional composition; 11.5 grams to 33 grams of carbohydrate per 100 mL of the nutritional composition; 50 milligrams to 500 milligrams of fat per 100 mL of the nutritional composition. In addition, the liquid nutritional composition has a viscosity of 25 centipoise to 100 centipoise, a caloric density of 50 kcal to 200 kcal per 100 mL of the nutritional composition, and a pH of 2 to 4.6.

In one exemplary embodiment, a translucent, high acid, low viscosity, high caloric density liquid nutritional composition is provided. The liquid nutritional composition comprises 3 grams to 10.5 grams of protein per 100 mL of the nutritional composition; 11.5 grams to 33 grams of carbohydrate per 100 mL of the nutritional composition; 500 milligrams to 2 grams of fat per 100 mL of the nutritional composition; an emulsifier selected from the group consisting of lecithin, emulsifiers with a hydrophilic-lipophilic balance of 6 to 16, monoglycerides, diglycerides, polyglycerol esters, and combinations thereof. In addition, the liquid nutritional composition has a viscosity of 25 centipoise to 100 centipoise, a caloric density of 50 kcal to 200 kcal per 100 mL of the nutritional composition, and a pH of 2 to 4.6.

### DETAILED DESCRIPTION

Provided herein are liquid nutritional compositions that have a low viscosity and a high caloric density. The liquid nutritional compositions disclosed herein are translucent and acidic. Also provided herein are related methods of making the liquid nutritional compositions. The liquid nutritional compositions disclosed herein provide 3 grams to 10.5 grams of protein per 100 mL of composition, and also have a high caloric density (i.e., 0.5 kcal/mL to 2 kcal/mL), while also remaining translucent and displaying a low viscosity (i.e., 25 centipoise to 100 centipoise).

In a first exemplary embodiment, a translucent, high acid, low viscosity, high caloric density liquid nutritional composition is provided. The liquid nutritional composition comprises 3 grams to 10.5 grams of protein per 100 mL of the nutritional composition; 11.5 grams to 33 grams of carbohydrate per 100 mL of the nutritional composition; and 50 milligrams to 500 milligrams of fat per 100 mL of the nutritional composition. In addition, the liquid nutritional composition has a viscosity of 25 centipoise to 100 centipoise, a caloric density of 50 kcal to 200 kcal per 100 mL of the nutritional composition, and a pH of 2 to 4.6.

In a second exemplary embodiment, a translucent, high acid, low viscosity, high caloric density liquid nutritional composition is provided. The liquid nutritional composition comprises 3 grams to 10.5 grams of protein per 100 mL of the nutritional composition; 11.5 grams to 33 grams of carbohydrate per 100 mL of the nutritional composition; 500 milligrams to 2 grams of fat per 100 mL of the nutritional composition; and an emulsifier selected from the group consisting of lecithin, emulsifiers with a hydrophobic-lipophilic balance between 6 and 16, monoglycerides, diglycerides, polyglycerol esters of fatty acids, and combinations thereof. The liquid nutritional composition has a viscosity of 25 centipoise to 100 centipoise, a caloric density of 50 kcal to 200 kcal per 100 mL of the nutritional composition, and a pH of 2 to 4.6.

Exemplary embodiments disclosed herein provide liquid nutritional compositions that are translucent and have a high caloric density and a low viscosity. The phrase “high caloric density” as used herein refers to a calorie content that is 50 kcal to 200 kcal per 100 mL of the liquid nutritional composition. The phrase “low viscosity” as used herein refers to a viscosity of 25 centipoise to 100 centipoise (as measured at 22.5° C.±0.5° C., and described further below).

It should be understood that when discussing the liquid nutritional compositions herein, that the discussion is equally applicable to nutritional compositions that are produced according to the disclosed methods. In other words, in certain exemplary embodiments, the disclosed methods can be viewed as methods for preparing a liquid nutritional composition according to the first exemplary embodiment disclosed herein or a liquid nutritional composition according to the second exemplary embodiment disclosed herein. However, it should also be understood that the exemplary methods described herein can also be used to prepare nutritional compositions that vary in one or more ways from the liquid nutritional compositions of the first and second exemplary embodiments.

As used herein, the terms “translucent” and “translucency,” unless otherwise specified, refers to a liquid having a visibly translucent appearance. Translucency in this context may be measured by formazin nephelometric unit (FNU) at 90 degree light scattering and 860 nm with a Nephla reader. A translucent liquid nutritional composition, as used herein, refers to a liquid nutritional composition with a FNU of less than 5,000 (e.g., 50 to 5,000), less than 2,500 (e.g., 50 to 2,500), less than 1,000 (e.g., 50 to 1,000), less than 500 (e.g., 50 to 500), or less than 200 (e.g., 50 to 200). In certain exemplary embodiments, the translucent liquid nutritional composition has a FNU of 50 to 5,000, including 50 to 2,500; 50 to 1,000; 50 to 500; 50 to 200; 500 to 5,000; 1,000 to 5,000; or 2,500 to 5,000.

In certain exemplary embodiments, the liquid nutritional compositions are administered (or consumed) orally as needed to provide a desired level of nutrition. The liquid nutritional compositions are administered (or consumed) in the form of one to two servings daily or in one or multiple (e.g., two, three, four) divided doses daily. The serving size of the liquid nutritional compositions typically range from about 88 mL to about 300 mL, including from about 118 mL to about 250 mL, and also including from about 190 mL to about 240 mL. Various calorie contents may be associated with each serving of the exemplary liquid nutritional compositions such as, for example, about 44 kcal to about 600 kcal per serving, about 60 kcal to about 500 kcal per serving, or about 95 kcal to about 480 kcal per serving. In certain exemplary embodiments, the serving size of the liquid nutritional compositions are about 88 mL to about 150 mL (about 3 fl. oz. to about 5 fl. oz.), including about 118 mL (about 4 fl. oz.), and provide about 44 kcal to about 300 kcal per serving. Generally as used herein, a serving may be construed as any amount which is intended to be consumed in one sitting or within one hour or less.

As previously mentioned, exemplary liquid nutritional compositions described herein have a low viscosity, i.e., from 25 centipoise to 100 centipoise. In certain exemplary embodiments, the liquid nutritional compositions have a viscosity of 30 centipoise to 95 centipoise, a viscosity of 40 centipoise to 90 centipoise, a viscosity of 45 centipoise to 85 centipoise, a viscosity of 50 centipoise to 80 centipoise, a viscosity of 55 centipoise to 75 centipoise, or a viscosity of 60 centipoise to 70 centipoise. The viscosity values provided herein are measured at 22.5° C.±0.5° C., using a Brookfield Model LV Series (Model DV-II) Viscometer, with a #1 spindle installed, operated at 60 rpm (to create a shear rate of about 13 sec⁻¹). The Brookfield Viscometer is a rotational viscometer. It measures the torque required to rotate an immersed spindle in a fluid. The spindle is driven by a motor through a calibrated spring; deflection of the spring is indicated by a pointer and dial or a digital display. The viscous drag of the fluid against the spindle is measured by the spring deflection. The measurement range is determined by the rotational speed of the spindle, the size and shape of the spindle, the container the spindle is rotating within and the full scale torque of the calibrated spring. As those skilled in the art will appreciate, while viscosities can be measured under other conditions and according to different methods, modification of one or more test conditions may result in a different viscosity number.

As previously discussed, the exemplary liquid nutritional compositions described herein include 3 grams to 10.5 grams of protein per 100 mL of the liquid nutritional composition. In certain exemplary embodiments, the liquid nutritional composition includes 4 grams to 9 grams of protein per 100 mL of the liquid nutritional composition, 5 grams to 8 grams of protein per 100 mL of the liquid nutritional composition, or 6 grams to 7 grams of protein per 100 mL of the liquid nutritional composition. The amount of protein present in the exemplary liquid nutritional compositions described herein can also be characterized as a percentage of total calories in the liquid nutritional composition and may vary widely from about 5% to about 90%. In certain exemplary embodiments, the protein comprises about 5% to about 50%, about 8% to about 40%, about 8% to about 30%, about 8% to about 25%, about 8% to about 20%, about 10% to about 15%, about 6% to about 10%, or about 75% to about 85% of the total calories of the liquid nutritional composition.

In certain exemplary embodiments, the protein in the liquid nutritional composition is soluble protein, or a combination of soluble protein and non-soluble protein. For example, in certain exemplary embodiments, the soluble protein comprises about 65% to about 100% by weight of the total protein, about 80% to about 100% by weight of the total protein, about 85% to about 100% by weight of the total protein, about 90% to about 100% by weight of the total protein, about 95% to about 100% by weight of the total protein, or about 100% by weight of the total protein. Such amounts of soluble protein help achieve the desired translucency of the liquid nutritional compositions described herein.

The term “soluble protein” as used herein, unless otherwise specified, refers to those proteins having a protein solubility of at least about 40%, including from 50% to 100%, and also including from 60% to 90%, as measured in accordance with the following process: (1) suspend protein ingredient in purified water at 5.00 g per 100 g of suspension; (2) adjust the pH of the suspension to 3.5 or the desired product pH (e.g., 4.6) using HCl, Phosphoric Acid, Citric Acid or combinations thereof; (3) stir vigorously at room temperature (20° C.-22° C.) for 60 minutes; (4) measure total protein in the suspension by any suitable technique (including the HPLC technique described below); (5) centrifuge an aliquot of the suspension at 31,000×g and at 20° C. for 1 hour; (6) measure the supernatant for protein by the selected technique as described in step (4); and (7) calculate protein solubility as the supernatant protein percentage of the total protein.

Protein concentration (per step 4 above) can be measured in the protein solubility process by any known or otherwise suitable method for determining such concentrations, many of which are well known in the analytical art. An example of one such suitable method is by HPLC analysis in accordance with the following specifications: (1) Column: Shodex KW-804 protein size exclusion chromatography column, Waters P/N WAT036613; (2) Mobile Phase: 0.05M NaH₂PO₄, 0.15M NaCl, pH=7.0; (3) Flow Rate: 0.3 mL/minute; (4) Temperature: 22° C.; (5) Detection: UV at 214 nm; (6) Injection: 10 μL; (7) Run Time: 90 minutes; (8) System Calibration: protein standard solutions prepared at 0.5-3.0 g/L in mobile phase; and (9) Sample Preparation: dilute to about 1.5 g/L protein with mobile phase.

Any soluble protein source is suitable for use herein provided that it meets the solubility requirement as defined herein. In certain exemplary embodiments, the protein comprises soluble protein selected from the group consisting of whey protein, whey protein isolate, whey protein hydrolysate, collagen, hydrolyzed collagen, pea protein, pea protein hydrolysate, soy protein, soy protein hydrolysate, casein hydrolysate, canola protein, potato protein, potato protein isolate, potato protein hydrolysate, and combinations thereof. As mentioned above, non-soluble proteins may comprise a portion of the total protein of the liquid nutritional compositions described herein provided that the soluble protein portion of the total protein is at least 65%, as discussed above. In certain exemplary embodiments, the liquid nutritional compositions may be substantially free of proteins other than the soluble protein as described herein (i.e., less than 1% of the total protein in the liquid nutritional composition is non-soluble protein).

It should be noted, however, that any protein selected for use herein as a soluble protein must also meet the solubility testing requirements noted above even if the protein is characterized as whey protein concentrate, casein hydrolysate, or other typically soluble protein, since protein solubility can vary significantly with the selection of raw material lots, sources, brands, and so forth.

In accordance with the exemplary embodiments described herein, the liquid nutritional composition includes 11.5 grams to 33 grams of carbohydrate per 100 mL of the liquid nutritional composition. In certain exemplary embodiments, the liquid nutritional composition includes 15 grams to 30 grams, 20 grams to 30 grams, or 25 grams to 30 grams of carbohydrate per 100 mL of the liquid nutritional composition. The carbohydrate may be provided by a single source or by more than one source. The particular amount of carbohydrate present in the liquid nutritional compositions may vary depending upon the desired amount of calories in the nutritional compositions. The amount of carbohydrate present in the exemplary liquid nutritional compositions described herein can also be characterized as a percentage of total calories in the nutritional composition and may vary widely from about 20% to about 95%. In certain exemplary embodiments, the carbohydrate comprises about 23% to about 92%, about 30% to about 85%, about 55% to about 80%, about 60% to about 75%, about 65% to about 70%, about 20% to about 30%, or about 80% to about 95% of the total calories of the liquid nutritional composition.

Various sources of carbohydrate are available and may be utilized in the exemplary liquid nutritional compositions described herein. Non-limiting examples of suitable carbohydrate or sources thereof for use in the exemplary liquid nutritional compositions disclosed herein include maltodextrin; native, hydrolyzed or modified starch or cornstarch; isomaltulose; glucose polymers; corn syrup; corn syrup solids; rice-derived carbohydrates; glucose; fructose; lactose; sucrose; high fructose corn syrup; honey; sugar alcohols (e.g., maltitol, erythritol, sorbitol); slow digesting starches; barley beta glucan; glycerin; sucromalt; inulin; and combinations thereof.

The exemplary liquid nutritional compositions described herein include fat or at least one source of fat. As previously mentioned, in one exemplary embodiment, the liquid nutritional composition includes 50 milligrams to 500 milligrams of fat per 100 mL of the liquid nutritional composition. In certain exemplary embodiments, the liquid nutritional composition includes about 75 milligrams to about 450 milligrams, about 100 milligrams to about 400 milligrams, or about 200 milligrams to about 300 milligrams of fat per 100 mL of the liquid nutritional composition. The amount of fat present in the liquid nutritional composition, according to certain exemplary embodiments having 50 milligrams to 500 milligrams of fat per 100 mL of the liquid nutritional composition, can also be characterized as a percentage of total calories in the liquid nutritional composition and may vary from about 0.2% to about 9%. In certain exemplary embodiments, the fat comprises about 0.2% to about 7%, about 0.2% to about 5%, about 0.2% to about 2.5%, about 0.2% to about 1%, or about 0.2% to about 0.8% of the total calories of the liquid nutritional composition. The total amount of fat may be provided by at least one source of fat, or by an ingredient that inherently includes some amount of fat (e.g., protein), or both.

In one exemplary embodiment, the liquid nutritional composition includes 500 milligrams to 2 grams of fat per 100 mL of the liquid nutritional composition. In certain exemplary embodiments, the liquid nutritional composition includes about 750 milligrams to about 1.75 grams, about 1 gram to about 1.5 grams, about 1 gram to about 2 grams, or about 500 milligrams to about 1 gram of fat per 100 mL of the liquid nutritional composition. The amount of fat present in the liquid nutritional composition, according to certain exemplary embodiments having 500 milligrams to 2 grams of fat per 100 mL of the liquid nutritional composition, can also be characterized as a percentage of total calories in the liquid nutritional composition and may vary from about 2% to about 36%. In certain exemplary embodiments, the fat comprises about 2.5% to about 30%, about 3% to about 25%, about 5% to about 15%, about 2% to about 5%, about 20% to about 30%, or about 25% to about 36% of total calories of the liquid nutritional composition. The total amount of fat may be provided by at least one source of fat, or by an ingredient that inherently includes some amount of fat (e.g., protein), or both.

Various sources of fat are available and may be utilized in the exemplary liquid nutritional compositions described herein. Non-limiting examples of suitable fats or sources thereof for use in the exemplary liquid nutritional compositions disclosed herein include coconut oil, fractionated coconut oil, soy oil, corn oil, olive oil, safflower oil, high oleic safflower oil, MCT (medium chain triglycerides) oil, sunflower oil, high oleic sunflower oil, palm and palm kernel oils, palm olein, canola oil, fish oil, algal oil, cottonseed oils, lecithin, datem, mono- and diglycerides, milk phospholipids, polyglycerol esters of fatty acids, citric acid esters of fatty acids, and combinations thereof. In certain exemplary embodiments, at least a portion of the fat or source thereof is an omega-3 fatty acid selected from the group consisting of docosahexaenoic acid, eicosapentaenoic acid, α-linolenic acid, and combinations thereof. When an omega-3 fatty acid is present in an exemplary liquid nutritional composition, the total amount of omega-3 fatty acid is about 40 milligrams to about 215 milligrams per 100 mL of the liquid nutritional composition.

In certain exemplary embodiments when the liquid nutritional composition comprises 50 milligrams to 500 milligrams of fat per 100 mL of the liquid nutritional composition, the total combined amount of protein and fat is 3.1 grams to 11 grams per 100 mL of the liquid nutritional composition, and includes a minimum of 100 milligrams of fat per 100 mL of the liquid nutritional composition. In certain other exemplary embodiment when the liquid nutritional composition comprises 50 milligrams to 500 milligrams of fat per 100 mL of the liquid nutritional composition, the total combined amount of protein and fat is 3.2 grams to 11 grams, 3.3 grams to 11 grams, 3.4 grams to 11 grams, or 3.5 grams to 11 grams per 100 mL of the liquid nutritional composition, and includes a minimum of 200 milligrams of fat per 100 mL of the liquid nutritional composition.

In certain exemplary embodiments when the liquid nutritional composition comprises 500 milligrams to 2 grams of fat per 100 mL of the liquid nutritional composition, the total combined amount of protein and fat is 4 grams to 12.5 grams per 100 mL of the liquid nutritional composition, and includes a minimum of 1 gram of fat per 100 mL of the liquid nutritional composition. In certain other exemplary embodiment when the liquid nutritional composition comprises 500 milligrams to 2 grams of fat per 100 mL of the liquid nutritional composition, the total combined amount of protein and fat is 4.25 grams to 12.5 grams, 4.5 grams to 12.5 grams, or 5 grams to 12.5 grams per 100 mL of the liquid nutritional composition, and includes a minimum of 1.25 grams of fat per 100 mL of the liquid nutritional composition.

Liquid nutritional compositions according to exemplary embodiments having 500 milligrams to 2 grams of fat per 100 mL of the liquid nutritional composition include an emulsifier. In certain exemplary embodiments, the emulsifier is present in an amount of 0.5% to 5% by weight based on the total weight of fat in the liquid nutritional composition. In certain exemplary embodiments, the emulsifier is present in an amount of 0.5% to 4%, 0.5% to 3%, 0.5% to 2%, 0.5% to 1%, or 2.5% to 5% by weight based on the total weight of fat in the liquid nutritional composition. In certain exemplary embodiments, the emulsifier is present in an amount of 0.02% to 0.08% by weight based on the total weight of the liquid nutritional composition. In other exemplary embodiments, the emulsifier is present in an amount of 0.02% to 0.06%, 0.02% to 0.05%, or 0.02% to 0.04% by weight based on the total weight of the liquid nutritional composition.

In one exemplary embodiment, the emulsifier is lecithin. Lecithin is the popular and commercial name for a naturally occurring mixture of phosphatides (also called phospholipids or phosphoglycerides), which varies in color from light tan to dark, reddish brown and in consistency from a fluid to a plastic solid. Lecithin is the gummy material contained in crude vegetable oils and is generally removed from the oils by degumming. Soybeans are currently the most important source of commercial lecithin, and lecithin is the most important by-product of the soy oil processing industry because of its many applications in foods and industrial products. However, it should be understood that the present disclosure encompasses the use of lecithins other than soy-sourced lecithin. The three main phosphatides in the complex mixture sold commercially as soy lecithin are phosphatidyl choline, phosphatidyl ethanolamine (popularly called “cephalin”), and phosphatidyl inositols (also called inositol phosphatides). Commercial sources of soy lecithin also typically contain roughly 30-35% unrefined soy oil.

Soy lecithin can be classified into three broad types: unrefined/natural, refined, and chemically modified. Unrefined/natural lecithin comes in six basic varieties, long defined by specifications of the National Soybean Processors Association: plastic or fluid, each either unbleached, bleached, or double bleached. (Because fluid lecithins are easier to handle and dissolve more rapidly in various solvents, only small amounts of plastic grades are now produced.) Refined lecithin (which has had the oil removed using acetone) comes in three basic varieties: custom blended natural, oil free phosphatides (as is or custom blended), and alcohol-fractionated oil-free phosphatides (as is or custom blended). These latter special refined grades, which may contain 60-99.7% phosphatidyl choline, are used mostly for pharmaceutical applications and research. Chemically modified lecithin products, altered through selective chemical treatment, improve lecithin's compatibility with certain systems.

As previously mentioned, in certain exemplary embodiments, the liquid nutritional composition includes lecithin as an emulsifier. When present, the lecithin may be provided by a single source or by more than one source. In certain exemplary embodiments, lecithin is present in an amount of 0.02% to 0.08% by weight based on the total weight of the liquid nutritional composition. In other exemplary embodiments, lecithin is present in an amount of 0.02% to 0.06%, 0.02% to 0.05%, or 0.02% to 0.04% by weight based on the total weight of the liquid nutritional composition. In certain exemplary embodiments, lecithin is present in an amount based on the total amount of fat per 100 mL of nutritional composition. In one exemplary embodiment, lecithin is present in an amount of 0.5% to 5% by weight based on the total weight of fat in the liquid nutritional composition. In certain exemplary embodiments, lecithin is present in an amount of 0.5% to 4%, 0.5% to 3%, 0.5% to 2%, 0.5% to 1%, or 2.5% to 5% by weight based on the total weight of fat in the liquid nutritional composition. Commercial sources of lecithin suitable for use in certain exemplary embodiments described herein include soy lecithin and sunflower lecithin among others, non-limiting examples of which include: natural unbleached lecithin available from Solae (St. Louis, Mo.) and acetylated lecithin available from ADM Company (Decatur, Ill.).

In certain exemplary embodiments, the emulsifier may be an emulsifying agent other than lecithin, or in addition to lecithin. Other suitable emulsifying agents include mono- and diglycerides, polyglycerol esters of fatty acids, milk phospholipids, citric acid esters of fatty acids, and datem. Moreover, other emulsifying agents suitable for use in certain exemplary embodiments of liquid nutritional compositions having 500 milligrams to 2 grams of fat per 100 mL of the liquid nutritional composition include emulsifiers with a hydrophilic-lipophilic balance (HLB) between 6 and 16 including, but not limited to certain lecithins.

In certain exemplary embodiments, the liquid nutritional compositions may comprise an anti-foaming agent. The anti-foaming agent helps control the formation of foam, particularly foam generation from the protein. Non-limiting examples of anti-foaming agents suitable for use in the liquid nutritional compositions disclosed herein include: simethicone, lecithin, milk phospholipids, dimethylpolysiloxane, silicone dioxide, and combinations thereof. In certain exemplary embodiments, lecithin is present in an amount of 0.5% to 5% by weight based on the total weight of fat in the liquid nutritional composition. In certain exemplary embodiments, the liquid nutritional composition may comprise milk phospholipids, which may be present in an amount of 1% to 10% by weight based on the total weight of protein in the liquid nutritional composition.

In certain exemplary embodiments, the liquid nutritional compositions contain other ingredients, non-limiting examples of which include stabilizers, preservatives, antioxidants, buffers, pharmaceutical actives, specialty nutrient ingredients, colorants, flavors, vitamins, and minerals. In certain exemplary embodiments, the liquid nutritional compositions include a stabilizer selected from the group consisting of octenyl succinic anhydride, gellan gum, alginate, pectin, guar gum, locust bean gum, konjack, carboxymethyl cellulose, microcrystalline cellulose, and combinations thereof. Those of skill in the art will recognize that many different gum forms, in addition to those listed above, may be used in the liquid nutritional compositions disclosed herein and still fall within the disclosed embodiments.

In certain exemplary embodiments, the liquid nutritional compositions contain vitamins or related nutrients, non-limiting examples of which include vitamin A, vitamin C, vitamin D, vitamin E, vitamin K, thiamine, riboflavin, pyridoxine, vitamin B12, carotenoids (e.g., beta-carotene, lycopene, lutein), niacin, folic acid, pantothenic acid, biotin, choline, inositol, salts, and derivatives thereof, and combinations thereof.

In certain exemplary embodiments, the liquid nutritional compositions contain minerals, non-limiting examples of which include calcium, phosphorus, magnesium, iron, zinc, manganese, copper, sodium, potassium, molybdenum, chromium, selenium, iodine, and combinations thereof.

The liquid nutritional compositions, according to certain exemplary embodiments, may further include a specialty nutrient ingredient. The specialty nutrient ingredient may be an ingredient that promotes muscle protein synthesis, reduces muscle protein degradation, increases muscle strength, mass, and endurance, exhibits anti-oxidant and anti-inflammatory activity, and combinations thereof. In certain exemplary embodiments, the liquid nutritional compositions further comprise a specialty nutrient ingredient selected from the group consisting of beta-alanine, calcium β-hydroxy-β-methylbutyrate, EGCg, beta glucan, mulberry extract, and combinations thereof

In certain exemplary embodiments, the liquid nutritional compositions further comprise β-hydroxy-β-methylbutyrate (HMB). HMB is a metabolite of the essential amino acid leucine, and has the IUPAC name 3-hydroxy-3-methylbutanoic acid. One useful form of HMB is the calcium salt of HMB, also designated as Ca-HMB, which is most typically the monohydrate calcium salt. The HMB used in the exemplary liquid nutritional compositions described herein can come from a wide variety of sources. For example, Ca-HMB monohydrate is commercially available from Lonza (Switzerland) or Technical Sourcing International (TSI) (Salt Lake City, Utah). Note that all of the amounts of HMB described herein are based on use of Ca-HMB monohydrate.

Although calcium monohydrate is the preferred form of HMB for use herein, other suitable sources include HMB as a free acid, a salt, an anhydrous salt, an ester, a lactone, or other product forms that provide a bioavailable form of HMB suitable for administration. Non-limiting examples of suitable salts of HMB for use herein include HMB salts, hydrated or anhydrous, of sodium, potassium, chromium, calcium, or other non-toxic salt forms.

In certain exemplary embodiments, the liquid nutritional composition comprises 0.4 grams to 4 grams of HMB per serving. For example, in certain exemplary embodiments, the liquid nutritional composition comprises 0.5 grams to 3.5 grams, 0.5 grams to 2.5 grams, 1 gram to 2 grams, or 1 gram to 1.5 grams of HMB per serving. In certain exemplary embodiments, the liquid nutritional composition includes 1.5 grams of HMB per serving. In certain other exemplary embodiments, the weight percent of HMB (based on the total weight of the liquid nutritional composition) may range up to 10%. For example, in certain exemplary embodiments, the liquid nutritional composition includes HMB at a weight percent of 0.01% to 10%, 0.1% to 5.0%, 0.5% to 2%, or 0.4% to 1.5% (based on the total weight of the liquid nutritional composition).

The liquid nutritional composition, according to certain exemplary embodiments, may further comprise β-alanine β-alanine is a naturally occurring β amino acid that is the rate-limiting precursor of carnosine. Dietary supplementation with β-alanine has been shown to increase the concentration of carnosine in muscles, delay fatigue in athletes, and increase total muscular work done. In certain exemplary embodiments, the liquid nutritional composition comprises 0.1 grams to 10 grams of β-alanine per serving. In certain other exemplary embodiments, the liquid nutritional composition comprises 0.1 grams to 6 grams, 0.5 grams to 4 grams, 1 gram to 3.5 grams, or 1.25 grams to 2 grams of β-alanine per serving. In certain exemplary embodiments where the liquid nutritional composition contains β-alanine, the weight percent of β-alanine (based on the total weight of the liquid nutritional composition) may range from 0.01% to 5%. In certain other exemplary embodiments, the liquid nutritional composition includes β-alanine at a weight percent of 0.1% to 2%, 0.1% to 1%, or 0.1% to 0.5% (based on the total weight of the liquid nutritional composition).

The β-alanine may be provided in various forms. For example, the β-alanine may be provided in free form or as a derivative (e.g., salt, ester, lactone). All amounts of β-alanine referred to herein refer to either free β-alanine or the β-alanine portion of the salt, ester, or lactone. A wider variety of β-alanine sources may be suitable for use in certain exemplary embodiments of the liquid nutritional compositions described herein. In certain exemplary embodiments, the β-alanine is free β-alanine Free beta-alanine is commercially available from Lonza (Switzerland) and Compounds Solutions (Escondido, Calif.).

In certain exemplary embodiments, the liquid nutritional composition may comprise epigallocatechin-3-gallate (“EGCg”) or a source thereof. EGCg is a polyphenol, more specifically a flavan-3-ol or catechin, that exhibits anti-oxidant and anti-inflammatory properties. Generally, EGCg is the most abundant polyphenol present in green tea. In certain exemplary embodiments, the liquid nutritional composition may include 0.1 grams to 5 grams of EGCg (or a source thereof) per serving. For example, in certain exemplary embodiments, the liquid nutritional composition comprises 0.5 grams to 4 grams, 0.5 grams to 2.5 grams, 1 gram to 2 grams, or 1 gram to 1.5 grams of EGCg per serving. In certain exemplary embodiments where the liquid nutritional composition contains EGCg, the weight percent of EGCg (based on the total weight of the liquid nutritional composition) may range from 0.01% to 10%. In certain other exemplary embodiments, the liquid nutritional composition includes EGCg at a weight percent of 0.1% to 5%, 0.5% to 2%, or 0.4% to 1.5% (based on the total weight of the liquid nutritional composition).

The EGCg used in connection with the liquid nutritional compositions described herein may be provided by natural or synthetic sources. Suitable sources of EGCg for use in the liquid nutritional compositions are green tea-based sources including, but not limited to, green tea extracts in which EGCg alone, or in combination with other polyphenol compounds (e.g., other flavan-3-ols), are isolated from green tea as an extract. Examples of such suitable green tea extracts are in the form of a liquid with a high concentration of the polyphenols, a solid (e.g., a powder), and mixtures thereof. Examples of commercially available sources of EGCg provided as part of a green tea extract include Teavigo® (>90% EGCg) (DSM, Netherlands) and SUNPHENON® 90D (Taiyo International, Inc., Minneapolis, Minn.).

In certain other exemplary embodiments, the liquid nutritional compositions may comprise a source of EGCg other than, or in addition to, a green tea-based source of EGCg. These non-green tea-based sources of EGCg include, but are not limited to, oolong tea-based sources such as oolong tea, oolong tea extracts, and the like; white tea-based sources such as white tea, white tea extracts, and the like; macha tea, macha tea extracts, and the like; yellow tea, yellow tea extracts, and the like; and dark tea (i.e., Chinese dark tea), dark tea extracts, and the like.

In certain exemplary embodiments, the liquid nutritional compositions optionally include one or more flavoring agents. Suitable flavoring agents include, but are not limited to, natural and artificial sweeteners, sodium sources such as sodium chloride, and combinations thereof.

The exemplary translucent, high acid, low viscosity, high caloric density liquid nutritional compositions described herein may be manufactured by any known or otherwise suitable method for making acidic beverages including, but not limited to, aseptic and hot filling processes. In one exemplary embodiment, a hot fill process (as described below) is utilized to prepare a translucent, low viscosity, high caloric density liquid nutritional composition.

A hot fill process, according to one exemplary embodiment, includes dissolving the protein component in water at a temperature of about 21° C. (70° F.) up to about 57° C. (135° F.). After the protein component is dissolved to form a first slurry, the first slurry is adjusted to a pH of about 2.8 to about 4.2 using an appropriate acid system such as, for example, phosphoric acid, citric acid, or both.

A second slurry is prepared by dissolving the carbohydrate component in water at an elevated temperature such as, for example, 80° C. (175° F.). An oil blend may be prepared by heating the required amount of fat and optional emulsifier to a temperature of, for example, about 26° C. (about 80° F.) to about 33° C. (about 90° F.). The first slurry, the second slurry, and the oil blend are blended together, homogenized, and vitamins and minerals are added into the resulting slurry. Once a final homogenized slurry is prepared, the resulting slurry is heated to a temperature of at least about 82° C. (180° F.), or desirably at least about 93° C. (200° F.), and held at that temperature for at least about 20 seconds to kill mold, bacteria, and yeast. Prior to filling a suitable plastic or other container with the hot liquid, the liquid may optionally be rapidly cooled to 60° C. (140° F.) to 66° C. (150° F.). By filling the hot liquid into the container, the container itself is also sterilized. Generally, during or after the filling of the hot liquid, the container is rotated so that the headspace area is also sterilized.

In accordance with certain of the preceding exemplary embodiments, the translucent, high acid, low viscosity, high caloric density, liquid nutritional compositions are ready-to-drink liquid nutritional products. As used herein “ready-to-drink” refers to a product which may be consumed without further preparation (i.e., it does not need to be mixed, cooked, diluted). In accordance with certain exemplary embodiments, the ready-to-drink liquid nutritional compositions are shelf-stable. As used herein, the term “shelf-stable” refers to a liquid nutritional composition that remains commercially stable after being packaged and then stored at 18-25° C. (64-77° F.) for up to 18 months following packaging.

### EXAMPLES

The following examples illustrate certain exemplary embodiments of the translucent, high acid, low viscosity, high caloric density, liquid nutritional compositions described herein. The examples are given solely for the purpose of illustration and are not to be construed as limitations of the general inventive concepts, as many variations thereof are possible without departing from the spirit and scope of the general inventive concepts.

### Example 1

Examples 1 illustrates an exemplary translucent, high acid, low viscosity, high caloric density liquid nutritional composition. All ingredient amounts listed in Example 1 are listed as kilogram per 1000 kg batch of product, unless otherwise indicated.

EXAMPLE 1

| INGREDIENTS | Amount (kg/1000 kg) |
|---|---|
| Water | Quantity Sufficient |
| Sucrose | 132 |
| Corn syrup solids | 123 |
| Acidified Whey Protein Isolate | 109 |
| Citric Acid | 2.00 |
| Flavoring | 2.00 |
| Ascorbic Acid | 0.535 |
| Liquid Sucralose (25%) | 0.275 |
| Ultra Trace Mineral/Trace Mineral Premix | 0.230 |
| Vitamin Premix¹ | 0.219 |
| Acesulfame Potassium | 0.110 |
| Antifoam processing aid (non-silicone) | 0.060 |
| Coloring | 0.0589 |
| Folic Acid | 0.0013 |
| Potassium Iodide | 0.000204 |

¹Vitamin premix includes one or more of the following: dl-Alpha-Tocopheryl Acetate, Vitamin A Palmitate, Phylloquinone, Vitamin D3, Niacinamide, d-Calcium Pantothenate, Thiamine Chloride Hydrochloride, Pyridoxine Hydrochloride, Riboflavin, Folic Acid, Biotin, Cyanocobalamin, etc.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative compositions and processes, and illustrative examples shown and described. Accordingly, departures may be made from such details without departing from the spirit or scope of the applicant's general inventive concept.

1. A translucent, high acid, low viscosity, high caloric density liquid nutritional composition comprising:
a) 3 grams to 10.5 grams of protein per 100 mL of the nutritional composition;
b) 11.5 grams to 33 grams of carbohydrate per 100 of the nutritional composition; and
c) 50 milligrams to 500 milligrams of fat per 100 mL of the nutritional composition;
wherein the nutritional composition has a viscosity of 25 centipoise to 100 centipoise, a caloric density of 50 kcal to 200 kcal per 100 mL of the nutritional composition, and a pH of 2 to 4.6.

2. The liquid nutritional composition of claim 1, wherein the protein comprises soluble protein selected from the group consisting of whey protein, whey protein isolate, whey protein hydrolysate, collagen, hydrolyzed collagen, pea protein, pea protein hydrolysate, soy protein, soy protein hydrolysate, casein hydrolysate, canola protein, potato protein, and combinations thereof.

3. The liquid nutritional composition of claim 1, wherein the nutritional composition has a viscosity of 40 centipoise to 90 centipoise.

4. The liquid nutritional composition of claim 1, further comprising a stabilizer selected from the group consisting of octenyl succinic anhydride, gellan gum, micro crystalline cellulose, guar gum, and combinations thereof.

5. The liquid nutritional composition of claim 1, wherein the total combined amount of protein and fat is from 3.1 grams to 11 grams per 100 mL of the nutritional composition.

6. The liquid nutritional composition of claim 1, further comprising an anti-foaming agent selected from the group consisting of simethicone, dimethylpolysiloxane, silicone dioxide, and combinations thereof.

7. The liquid nutritional composition according to claim 1, wherein at least a portion of the fat comprises an omega-3 fatty acid selected from the group consisting of docosahexaenoic acid, eicosapentaenoic acid, a-linolenic acid, and combinations thereof, wherein the total amount of omega-3 fatty acid is from 40 milligrams to 215 milligrams per 100 mL of the nutritional composition.

8. The liquid nutritional composition according to claim 1, further comprising a specialty nutrient ingredient selected from the group consisting of beta-alanine, calcium β-hydroxy-P-methylbutyrate, EGCg, beta glucan, mulberry extract, and combinations thereof.

9. A translucent, high acid, low viscosity, high caloric density liquid nutritional composition comprising:
a) 3 grams to 10.5 grams of protein per 100 mL of the nutritional composition;
b) 11.5 grams to 33 grams of carbohydrate per 100 mL of the nutritional composition;
c) 500 milligrams to 2 grams of fat per 100 mL of the nutritional composition; and
d) an emulsifier selected from the group consisting of lecithin, emulsifiers with a hydrophilic-lipophilic balance of 6 to 16, monoglycerides, diglycerides, polyglycerol esters, and combinations thereof;
wherein the nutritional composition has a viscosity of 25 centipoise to 100 centipoise, a caloric density of 50 kcal to 200 kcal per 100 mL of the nutritional composition, and a pH of 2 to 4.6.

10. The liquid nutritional composition of claim 9, wherein the protein comprises soluble protein selected from the group consisting of whey protein, whey protein isolate, whey protein hydrolysate, collagen, hydrolyzed collagen, pea protein, pea protein hydrolysate, soy protein, soy protein hydrolysate, casein hydrolysate, canola protein, potato protein, and combinations thereof.

11. The liquid nutritional composition of claim 9, further comprising a stabilizer selected from the group consisting of octenyl succinic anhydride, gellan gum, microcrystalline cellulose, guar gum, and combinations thereof.

12. The liquid nutritional composition of claim 9, wherein the total combined amount of protein and fat is from 4 grams to 12.5 grams per 100 mL of the nutritional composition.

13. The liquid nutritional composition of claim 9, further comprising an anti-foaming agent selected from the group consisting of simethicone, dimethylpolysiloxane, silicone dioxide, and combinations thereof.

14. The liquid nutritional composition of claim 9, wherein the nutritional composition has a viscosity of 40 centipoise to 90 centipoise.

15. The liquid nutritional composition according to claim 9, wherein at least a portion of the fat comprises an omega-3 fatty acid selected from the group consisting of docosahexaenoic acid, eicosapentaenoic acid, a-linolenic acid, and combinations thereof, wherein the total amount of omega-3 fatty acid is from 40 milligrams to 215 milligrams per 100 mL of the nutritional composition.

16. The liquid nutritional composition according to claim 9, further comprising a specialty nutrient ingredient selected from the group consisting of beta-alanine, calcium P-hydroxy-P-methylbutyrate, EGCg, beta glucan, mulberry extract, and combinations thereof.

17. The liquid nutritional composition according to claim 9, wherein the emulsifier is lecithin and the lecithin is present in an amount from 0.5% to 5% by weight based on the total weight of fat in the nutritional composition.
